(19) United States
(12) Patent Application Publication
(10) Pub. No.: US 2026/0296568 A1
(43) Pub. Date: Oct. 1, 2026

(54) MOULDED STRUCTURAL COMPONENT FOR A PASSENGER VEHICLE

(71) Applicant: Silverstone Performance Technologies Limited, Towcester Northamptonshire (GB)

(72) Inventor: Claudio SANTONI, Silverstone, Towcester Northamptonshire (GB)

(21) Appl. No.: 19/478,566

(22) PCT Filed: Apr. 26, 2024
(86) PCT No.: PCT/GB2024/051110

§ 371 Date: Oct. 24, 2025

(30) Foreign Application Priority Data
Apr. 26, 2023 (GB) 2306140.1

(51) Int. Cl. B62D 29/04; B62D 23/00; B62D 25/20

(52) U.S. Cl. CPC B62D 29/046; B62D 23/00; B62D 25/2036

(57) ABSTRACT

A moulded structural component for the cabin of a passenger vehicle, the structural component comprising: a lateral wall facing a rear end of the structural component, the lateral wall being spaced from the rear end of the structural component along a principal axis of the structural component; opposing first and second sidewalls, each extending from the lateral wall towards the rear end of the structural component; and a floor extending between the lateral wall and the first and second sidewalls and towards the rear end of the structural component, the lateral wall, the first and second sidewalls and the floor being integral and together defining an interior space of the structural component for housing one or more passengers; wherein the first and second sidewalls and the floor define an open rear end of the structural component and the distance between interior-side faces of the first and second sidewalls is substantially constant or increases from the lateral wall towards the open rear end of the structural component along the direction of the principal axis such that the structural component may be demoulded from a rigid tool part of a moulding apparatus forming the structural component along a direction Within 20° of the principal axis of the structural component.

### FIELD OF THE INVENTION

The invention relates to moulded structural components for the cabin of a passenger vehicle. In particular, the invention relates to a structural component manufactured by resin transfer moulding of fibre-reinforced composite materials.

### BACKGROUND

Fibre-reinforced composite materials are increasingly being used in the manufacture of passenger road vehicles. A common technique for manufacturing fibre-reinforced components is resin transfer moulding. This technique uses a set of moulds to define a mould cavity for the component being manufactured. Fibre reinforcement is placed between the moulds so as to be inside the mould cavity before a resin matrix material is introduced into the cavity. Once the resin matrix has set on the fibre reinforcement, the moulds are separated and the component removed.

It is desirable to use as few separate moulded structural components as possible in the construction of the cabin of a passenger vehicle, as any location where separate moulded components must be joined together is a point that may be subject to adjustments for manufacturing tolerances, requires the use of extra joining materials, and also introduces a point of weakness into the cabin. For example, a large number of small simple components may be moulded to be joined together, but these may need to be manually adjusted to ensure they fit together as intended and each join is expensive and time consuming to make. However, the use of large complex moulded structures makes the moulding process more difficult.

An example of a technique for moulding a structural tub for a vehicle may be found in WO 2011113912 A1. This structural component defines a main compartment bounded by a first lateral wall, a second lateral wall and a floor, and also has a strengthening member integral with the first lateral wall that projects towards the second lateral wall. Once moulded, this structural component is removed from the moulding tool by a motion that includes rotation about the strengthening member. However, this design imparts limitations on the shape of the structural tub and also requires a complex motion to be used to extract the moulded structure from the mould. Furthermore, each different sized structural tub, for example for different sized vehicles, requires its own design, a corresponding mould, and its own extraction motion from that mould, significantly increasing the complexity of implementing these designs across a range of vehicles.

It is an aim of this invention to provide moulded structural components that form a significant part of the cabin of a passenger vehicle while also being readily manufacturable by moulding processes and having wider application among passenger vehicles.

### SUMMARY OF INVENTION

In accordance with a first aspect of the present invention, there is provided a moulded structural component for the cabin of a passenger vehicle, the structural component comprising: a lateral wall facing a rear end of the structural component, the lateral wall being spaced from the rear end of the structural component along a principal axis of the structural component; opposing first and second sidewalls, each extending from the lateral wall towards the rear end of the structural component; and a floor extending between the lateral wall and the first and second sidewalls and towards the rear end of the structural component, the lateral wall, the first and second sidewalls and the floor being integral and together defining an interior space of the structural component for housing one or more passengers; wherein the first and second sidewalls and the floor define an open rear end of the structural component and the distance between interior-side faces of the first and second sidewalls is substantially constant or increases from the lateral wall towards the open rear end of the structural component along the direction of the principal axis such that the structural component may be demoulded from a rigid tool part of a moulding apparatus forming the structural component along a direction within 20° of the principal axis of the structural component.

The structural component according to the present aspect is therefore designed so that the lateral wall, which may for example correspond to the front wall of the cabin of a passenger vehicle, faces an open rear end of the structural component to enable the component to be removed from a moulding tool defining the inner surface of the structural component along an extraction direction within 20° of the principal axis. Here, the inner surface refers to the surfaces of the lateral wall, the first and second sidewalls and the floor which face the interior space defined by those parts, e.g. that face generally towards the space between the first and second sidewalls. It will be understood that this is intended to mean that the structural component is shaped such that it can be demoulded from a rigid tool part defining the interior space by a translation movement along the direction within 20° of the principal axis. Whether or not a structural component can be demoulded along a particular direction can determined from the shape of the structural component. In particular, a structural component can be demoulded along a particular direction if a substantially straight line may be drawn from every point on the inner surface of the structural component along the same demoulding direction such that the line does not pass through any other surface of the structural component. This ensures that the moulding tool that forms the inside surface of the structural component can be translated along that demoulding direction without being restricted by another surface of the structural component. Preferably, the shape of the structural component is such that the demoulding may be performed with a pure translation movement, meaning that substantially no rotation of the component is required to remove the component from a rigid tool part defining the interior space. This makes the extraction motion of the moulded structural component simpler to perform. Furthermore, this design provides the additional benefit that the structural component no longer defines the length of the vehicle cabin, since the cabin may be extended from the open rear end of the structural component. For example, where a vehicle with a short cabin length is desired, for example for a two-seater sports car, the structural component may be joined with a second structural component that provides a second lateral wall, opposing the first lateral wall, located substantially at the open rear end of the structural component. However, where a longer cabin is desired, for example for a five-seater coupe, the structural component may be joined with a second structural component that continues the floor away from the open rear end of the structural component and defines a second lateral wall at a position spaced further from the first lateral wall. Thus, the present design can be more readily incorporated into a wider range of passenger vehicles while also being simpler to manufacture and extract from the moulding tool.

The structural component is defined as having a principal axis, which is the direction along which the lateral wall is spaced from the open rear end of the structural component. It will be understood that this generally corresponds to the front-back direction of the cabin of the passenger vehicle into which the structural component is to be incorporated. The principal axis will generally extend along a direction that is parallel to a direction that lies in the plane generally defined by the floor. The principal axis will also typically extend along a direction that is generally parallel to the directions along which the first and second sidewalls extend away from the lateral wall, and/or will extend along a direction that is perpendicular to a direction along which the first and second sidewalls are spaced from one another. The lateral wall and first and second sidewalls will also generally extend away from the floor along directions that include primary components perpendicular to the plane generally defined by the floor.

It will be appreciated that, as stated above, the structural component is one integral piece of composite material, which reflects that the structural component is generally produced in a single resin transfer moulding process. However, any final cabin of a passenger vehicle will typically be formed from two of more integral structural components joined together, as will be described in more detail below.

As indicated above, the structural component is shaped such that the structural component may be demoulded from a rigid tool part of a moulding apparatus forming the interior space of the structural component along an extraction direction that is within 20° of the principal axis of the structural component. It will be appreciated that this is primarily enabled by the open rear end of the structural component and the controlling of the spacing between the opposing side walls, as stated above. It will be appreciated that, more preferably, the structural component may be shaped such that the structural component may be demoulded from a rigid tool part of a moulding apparatus forming the structural component along an extraction direction within 10° of the principal axis of the structural component, and most preferably such that the structural component may be demoulded from a rigid tool part of a moulding apparatus forming the structural component substantially along the direction of the principal axis of the structural component. Additionally, preferably, substantially all distances in the interior space between the first and second sidewalls and the floor measured in cross section in a plane perpendicular to the extraction direction/principal axis are substantially constant or increase as the plane is moved along the extraction direction/principal axis from the lateral wall to the rear end of the structural component.

As indicated above, the lateral wall of the structural component typically corresponds to a front wall of the cabin of a passenger vehicle. The sidewalls extending away from this lateral wall and together defining a generally U-shaped structure in plan view contribute significantly to the overall strength and impact resistance of the structural component. These sidewalls may, along at least part of their length, correspond to the door sill regions of the chassis, and so may be relatively short compared to the height of the lateral wall, measured in the direction extending away from the floor. To further increase the strength of the structural component, these sidewalls may be part of respective first and second longitudinal strengthening members, such as substantially hollow beams, extending from the lateral wall towards the rear end of the structural component. In particular, the sidewalls may correspond to the inner side faces of these respective longitudinal strengthening members.

As indicated above, at least part of the sidewalls may need to be relatively low in a region of the component corresponding to a door sill. Nonetheless, preferably, a front portion of each sidewall, at an end proximate the lateral wall, extends further from the floor than a central portion of said sidewall, wherein preferably the front portion of each sidewall meets the lateral wall along a full height of said lateral wall and/or said respective sidewall. This arrangement ensures that the front portion of the structural component is particularly strong and impact resistant. This front region surrounded by the front portion of each sidewall and the lateral wall (and a front section of the floor) may correspond to the footwell region of the cabin, for example, and so this arrangement may be important for ensuring the safety of passengers in the case of impacts from the front.

Preferably, the structural component further comprises a lateral strengthening member extending between the first and second sidewalls at a front portion of each sidewall, at an end proximate the lateral wall, said strengthening member being spaced from the floor along a direction perpendicular to a plane generally defined by the floor. This lateral strengthening member further increases the overall strength and impact resistance of the structural component. The lateral strengthening member may also meet the lateral wall and extends from the lateral wall towards the rear end of the structural component. In other embodiments, the lateral strengthening member may wall extend from the lateral wall towards the rear end of the structural component, i.e. without necessarily meeting and extending between the first and second sidewalls. However, it will be appreciated that the strength of the structural component will be best served by this strengthening member meeting and being integral with all three of the lateral wall and the first and second sidewalls. The lateral strengthening member, lateral wall, first and second sidewalls, and the floor may therefore substantially surround a portion of the cabin, for example corresponding to the footwall, on five different sides to shield the passenger from impacts.

While separate tool parts could be designed for moulding this front section of the structural component, preferably this part of the structural component will be defined by the same tool part from which the structural component is to be removed by translation generally along the direction of the principal axis. Therefore, preferably a distance between interior-side faces of the floor and the lateral strengthening member is substantially constant or increases from the lateral wall towards the open rear end of the structural component along the full length of the lateral strengthening member along the extraction direction or direction of the principal axis. Similarly, preferably substantially all distances in the interior space between the front portions of the first and second sidewalls, the floor, and the lateral strengthening member measured in cross section in a plane perpendicular to the extraction direction/principal axis are substantially constant or increase as the plane is moved along the extraction direction/principal axis from the lateral wall towards the rear end of the structural component.

The design of the floor may also have a significant effect on the manufacturability and structural properties of the structural component. Preferably, a profile of an interior-side face of the floor in cross section in a plane perpendicular to the principal axis is substantially constant as the plane is moved along the principal axis from the lateral wall to the rear end of the structural component. This facilitates removal of the structural component from the rigid tool part.

Another consideration in the design of the floor is in how its shape may affect impact resistance of the overall structural component. Preferably, the floor is substantially flat (and continuous) between the first and second sidewalls along at least 10% of the length of the floor between the lateral wall and a rear edge of the floor at or towards the rear end of the structural component, preferably along at least 20% of the length of the floor, more preferably along at least 50% of the length of the floor. Providing that the floor is flat in one or more regions between the sidewalls ensures that these regions are better able to transmit crash forces across the structural component. While the flat floor could be provided by a series of regions that are individually quite narrow along the direction between the lateral wall and a rear edge of the floor, preferably the floor is substantially flat (and continuous) between the first and second sidewalls within at least one contiguous region extending along at least 10% of the length of the floor between the lateral wall and a rear edge of the floor at or towards the rear end of the structural component, preferably along at least 20% of the length of the floor, more preferably along at least 50% of the length of the floor. Preferably, of a central 50% of the floor between the lateral wall and the rear edge, the floor is substantially flat (and continuous) between the first and second sidewalls along at least 10% of the length of this central region the floor along the direction between the lateral wall and the rear edge, preferably at least 20%, more preferably at least 50%. By providing the flat region of floor in a central region of the floor along the length, the flat floor section may reinforce the weakest region of the structure. The central 50% may be determined relative to the longest measurement between the lateral wall and a rear edge of the floor along the direction of the principal axis. Preferably the sidewalls are at least 1 m apart, preferably at least 1.5 m apart, e.g. so that any flat regions may extend across the full width of the cabin.

Above, it is described that the floor is preferably flat in regions between the sidewalls. It is likewise preferable that the floor is substantially flat (and continuous) between the lateral wall and a rear edge of the floor at or towards the rear end of the structural component along at least 10% of the width of the floor between the first and second sidewalls, preferably along at least 20% of the width of the floor, more preferably along at least 50% of the width of the floor. Again, the floor may be substantially flat (and continuous) between the lateral wall and a rear edge of the floor at or towards the rear end of the structural component within at least one contiguous region extending along at least 20% of the width of the floor between the first and second sidewalls, preferably along at least 20% of the width of the floor, more preferably along at least 50% of the width of the floor. Preferably, of a central 50% of the floor between the first and second sidewalls, the floor is substantially flat (and continuous) between the lateral wall and the rear edge along at least 10% of the width of this central region the floor along the direction between the first and second sidewalls, preferably at least 20%, more preferably at least 50%. Again, this may reinforce the floor especially in a central region, where it would tend to be weakest. The central 50% may be determined relative to the longest measurement between the first and second sidewalls along a direction perpendicular to the principal axis. Preferably the lateral wall and the rear edge are at least 1 m apart, preferably at least 1.5 m apart, e.g. so that any flat regions may extend across the full length of the cabin.

Most preferably, the floor is substantially flat between the lateral wall, the first and second sidewalls and a rear edge of the floor at or towards the rear end of the structural component. A flat floor is better able to transmit impact forces through itself between the lateral walls and sidewalls without deforming. In contrast, deviations from flat may introduce a point at which the floor will preferentially deform during an impact. While it is preferred that the floor is substantially completely flat, in some embodiments at most 99% of the area of the floor is flat (and continuous), or at most 95%, or at most 90%, or at most 80%, or at most 75%. If a floor that is not substantially completely flat is provided, then following the above teachings regarding the arrangement of the flat floor sections, i.e. providing flat floor regions extending between the lateral wall and rear edge and/or between the first and second sidewalls, preferably in one or more large contiguous regions and preferably in large regions of the central 50% of the floor, can ensure that these deviations from flat provide a minimal compromise to the structural integrity of the structural component.

Similarly, preferably the floor is substantially continuous between the lateral wall, the first and second sidewalls and a rear edge of the floor at or towards the rear end of the structural component. Again, a continuous floor is better at transmitting impact forces, whereas any discontinuities in the floor may introduce a point at which the floor may preferentially deform. Discontinuities in the floor are often used as a way of introducing services (pipes, wirings, etc.) into the cabin of the passenger vehicle. However, this may also necessitate the inclusion of a surrounding structure for the service lines. If such a surrounding structure were to be formed integrally with the structural component, this would significantly limit how it may be formed while retaining the ability for the structural component to be extracted from the rigid tool part of the mould apparatus by translation in the manner described above. Accordingly, in the present structural component, the lateral wall may include an opening therethrough for permitting wiring and the like to pass between the interior space and an exterior of the structural component. Such an opening in the lateral wall does not impact the strength of the floor and also is positioned in a way that it will not impact the removal of the structural component from the moulding tool by translation generally along the direction of the principal axis.

It will be appreciated that, in the above embodiments, preferably no walls or projections extend from the first or second sidewalls or the floor into the interior space defining any face having an area, i.e. a projected area, in a plane perpendicular to the principal axis between the lateral wall and the rear end of the structural component. Any such surfaces may inhibit the removal of the structural component by pure translation; however, some such surfaces could be accommodated, if necessary, by translating the component along a direction that is close to but not exactly aligned with the principal axis. For example, surfaces extending from the floor that have a projected area in a plane perpendicular to the principal axis but which define an angle to the principal direction of no more than 20° may be accommodated by a demoulding direction that is equal to or greater than the angle of the surface.

In general, preferably the moulded structural component is formed as a single fibre reinforced composite piece. However, other types of composite structures may also be used.

A cabin of a passenger vehicle may comprise a first moulded structural component as described above and a second moulded structural component joined to the first moulded structural component, the second moulded structural component comprising a second lateral wall spaced from the lateral wall of the first moulded structural component along the principal axis of the first moulded structural component, such that the length of the cabin is defined by the first and second moulded structural components together.

Here, the second lateral wall may correspond to a rear wall of the cabin of the passenger vehicle, for example, against which seats may be mounted. This allows the cabin to define an enclosed space for a passenger between the lateral wall, opposing sidewalls, the second lateral wall and the floor, which improves the safety of the passenger, while still enabling the first structural component to be extracted from the mould in the manner described above.

The second moulded structural component may further comprise a roof spaced from the floor along a direction perpendicular to a plane generally defined by the floor of the first moulded structural component, the roof extending from the second lateral wall towards the lateral wall of the first moulded structural component, one of the first and second moulded structural components preferably further comprising first and second pillars extending between the roof and a front end of the first moulded structural component, such that together the first and second moulded structural components define a substantially enclosed interior space. Alternatively, the cabin may have no roof, for example for a convertible vehicle, or the roof could be defined by a third structural component, although this is generally less preferred as it requires additional joins to be made for each separate structural component of the cabin. Likewise, the pillars joining the roof to the first structural component could alternatively be separate structural components, but this is less preferred due to the additional joins that would be required.

A cabin of a passenger vehicle may also comprise a first moulded structural component as described above and a second moulded structural component joined to the first moulded structural component, the second moulded structural component comprising a floor extension portion, wherein the floor of the first moulded structural component and the floor extension portion together define an extended floor of the cabin that is longer than the floor of the first moulded structural component along the direction of the principal axis of the first moulded structural component. Preferably, the length of the floor extension portion along the direction of the principal axis is at least 5%, more preferably at least 10%, most preferably at least 20%, of the length of the floor of the first structural component.

This embodiment makes use of the fact that the open rear end of the first structural component does not place any limitation on the total length of the cabin. In particular, the cabin floor is defined by the first and second structural components in combination. It will be appreciated that the second structural component will also likewise define respective extension portions for the first and second sidewalls, so that these sidewalls also extend along the full cabin length. As described above, the second moulded structural component may also comprise a second lateral wall spaced from the lateral wall of the first moulded structural component along the principal axis of the first moulded structural component (e.g. by both the floor of the first structural component and the floor extension portion), such that the length of the cabin is defined by the first and second moulded structural components together.

The second moulded structural component may also comprise a roof spaced from the floor along a direction perpendicular to a plane generally defined by the floor of the first moulded structural component, one of the first and second moulded structural components preferably further comprising first and second pillars extending between the roof and a front end of the first moulded structural component, such that together the first and second moulded structural components define a substantially enclosed interior space.

In accordance with a second aspect of the present invention, there is provided a method of manufacturing a structural component for the cabin of a passenger vehicle, the method comprising: moulding the structural component between at least a rigid inner tool part and an outer tool part of a moulding apparatus, whereby the structural component comprises: a lateral wall facing a rear end of the structural component, the lateral wall being spaced from the rear end of the structural component along a principal axis of the structural component; opposing first and second sidewalls, each extending from the lateral wall towards the rear end of the structural component; and a floor extending between the lateral wall and the first and second sidewalls and towards the rear end of the structural component, the lateral wall, the first and second sidewalls and the floor being integral and together defining an interior space of the structural component for housing one or more passengers; wherein the first and second sidewalls and the floor define an open rear end of the structural component and the distance between interior-side faces of the first and second sidewalls is substantially constant or increases from the lateral wall towards the open rear end of the structural component along the direction of the principal axis; wherein the rigid inner tool part is located in the interior space during moulding; removing the outer tool part; and demoulding the structural component from the rigid inner tool part of the moulding apparatus along the a direction within 20° of the principal axis of the structural component.

This method corresponds to a method of manufacturing the structural component according to the first aspect of the invention. Accordingly, the method may also be adapted to manufacture the structural component in any of the preferred forms described above.

The method described above refers to a rigid inner tool part and an outer tool part, but other tool parts may be used in manufacturing the structural component. For example, it may be necessary to have separate first and second side tool parts for defining the outer sides of the first and second side walls, as well as breaking the outer tool part into multiple tool parts around the front section of the structural component, to allow for appropriate moulding of the lateral wall and lateral strengthening member, for example. Nonetheless, the present design of the structural component allows the structural component to be removed, e.g. by pure translation, along an extraction direction that is closely aligned with the direction of the principal axis. In these cases, preferably all tool parts are rigid tool parts.

In accordance with a third aspect of the present invention, there is provided a moulded structural component for the cabin of a passenger vehicle, the structural component comprising: a lateral wall facing a rear end of the structural component; opposing first and second sidewalls, each extending from the lateral wall towards the rear end of the structural component; and a floor extending between the lateral wall and the first and second sidewalls and towards the rear end of the structural component, the lateral wall, the first and second sidewalls and the floor being integral and together defining an interior space of the structural component for housing one or more passengers; wherein the floor is substantially continuous between the lateral wall, the first and second sidewalls and a rear edge of the floor towards the rear end of the structural component.

As indicated above, the use of a continuous floor in a structural component for the cabin of a passenger vehicle increases the strength and impact resistance of the floor and hence improves the overall strength of the resulting cabin.

Whereas openings in the floor may conventionally be used for introducing services (pipes, wirings, etc.) into the cabin of the passenger vehicle, in the present embodiments, preferably, the lateral wall includes an opening therethrough for permitting wiring and the like to pass between the interior space and an exterior of the structural component.

Again, preferably not only is the floor continuous, but flat regions should be provided to improve its ability to transmit impact forces across the floor. Preferably, the floor is substantially flat between the first and second sidewalls along at least 10% of the length of the floor between the lateral wall and the rear edge, preferably along at least 20% of the length of the floor, more preferably along at least 50% of the length of the floor. Preferably, the floor is substantially flat between the first and second sidewalls within at least one contiguous region extending along at least 10% of the length of the floor between the lateral wall and the rear edge, preferably along at least 20% of the length of the floor, more preferably along at least 50% of the length of the floor. Preferably, of a central 50% of the floor between the lateral wall and the rear edge, the floor is substantially flat between the first and second sidewalls along at least 10% of the length of this central region the floor along the direction between the lateral wall and the rear edge, preferably at least 20%, more preferably at least 50%. Preferably, a central 10% of the floor between the lateral wall and the rear edge of the floor is substantially flat, preferably a central 20%, more preferably the whole central 50% is substantially flat. By providing the flat region of floor in a central region of the floor along the length, the flat floor section may reinforce the weakest region of the structure. Preferably the sidewalls are at least 1 m apart, preferably at least 1.5 m apart, e.g. so that any flat regions may extend across the full width of the cabin.

Preferably, the floor is substantially flat between the lateral wall and the rear edge along at least 10% of the width of the floor between the first and second sidewalls, preferably along at least 20% of the width of the floor, more preferably along at least 50% of the width of the floor. Preferably, the floor is substantially flat between the lateral wall and the rear edge within at least one contiguous region extending along at least 10% of the width of the floor between the first and second sidewalls, preferably along at least 20% of the width of the floor, more preferably along at least 50% of the width of the floor. Preferably, of a central 50% of the floor between the first and second sidewalls, the floor is substantially flat between the lateral wall and the rear edge along at least 10% of the width of this central region the floor along the direction between the first and second sidewalls, preferably at least 20%, more preferably at least 50%. Preferably, a central 10% of the floor between the first and second sidewalls is substantially flat, preferably a central 20%, more preferably the whole central 50% is substantially flat. Again, this may reinforce the floor especially in a central region, where it would tend to be weakest. Preferably the lateral wall and the rear edge are at least 1 m apart, preferably at least 1.5 m apart, e.g. so that any flat regions may extend across the full length of the cabin.

Most preferably, the floor should be substantially flat between the lateral wall, the first and second sidewalls and a rear edge of the floor towards the rear end of the structural component, to further increase the strength of the floor of the structural component. While it is preferred that the floor is substantially completely flat, in some embodiments at most 99% of the area of the floor is flat, or at most 95%, or at most 90%, or at most 80%, or at most 75%. If a floor that is not substantially completely flat is provided, then following the above teachings regarding the arrangement of the flat floor sections, i.e. providing flat floor regions extending between the lateral wall and rear edge and/or between the first and second sidewalls, preferably in one or more large contiguous regions and preferably in large regions of the central 50% of the floor, can ensure that these deviations from flat provide a minimal compromise to the structural integrity of the structural component.

The structural component according to this aspect may also be provided with any of the features described above in relation to the first aspect of the invention.

In accordance with a variant of the above aspect, there may be provided a moulded structural component for the cabin of a passenger vehicle, the structural component comprising: a lateral wall facing a rear end of the structural component; opposing first and second sidewalls, each extending from the lateral wall towards the rear end of the structural component; and a floor extending between the lateral wall and the first and second sidewalls and towards the rear end of the structural component, the lateral wall, the first and second sidewalls and the floor being integral and together defining an interior space of the structural component for housing one or more passengers; wherein the floor is substantially flat and continuous between the lateral wall and a rear edge of the floor towards the rear end of the structural component along at least 10% (or 20% or 50%) of the width of the floor between the first and second sidewalls and the floor is substantially flat and continuous between the first and second sidewalls along at least 10% (or 20% or 50%) of the length of the floor between the lateral wall and the rear edge. Preferably, the substantially flat and continuous floor regions are provided in one or more large contiguous regions and preferably in central regions of the floor along either or both of the length and width of the floor, to ensure the structural integrity of the structural component.

In accordance with a fourth aspect of the present invention, there is provided a moulded structural component for the cabin of a passenger vehicle, the structural component comprising: a lateral wall facing a rear end of the structural component, the lateral wall being spaced from the rear end of the structural component along a principal axis of the structural component; opposing first and second sidewalls, each extending from the lateral wall towards the rear end of the structural component; and a floor extending between the lateral wall and the first and second sidewalls and towards the rear end of the structural component, the lateral wall, the first and second sidewalls and the floor being integral and together defining an interior space of the structural component for housing one or more passengers; wherein the first and second sidewalls and the floor define an open rear end of the structural component.

In the structural component according to this aspect of the invention, the structural component has an open rear end. For example, the floor may extend to a rear edge at or towards the rear end of the structural component. Accordingly, the structural component does not define the length of the vehicle cabin, since the cabin may be extended from the open rear end of the structural component. Thus, the present design can be more readily incorporated into a wider range of passenger vehicles.

The structural component according to this aspect may also be provided with any of the features described above in relation to the first aspect of the invention.

A cabin of a passenger vehicle may comprise a moulded structural component according to the fourth aspect of the invention and a second moulded structural component joined to the first moulded structural component, the second moulded structural component comprising a second lateral wall spaced from the lateral wall of the first moulded structural component along the principal axis of the first moulded structural component, such that the length of the cabin is defined by the first and second moulded structural components together.

Alternatively, or additionally, a cabin of a passenger vehicle may comprise a second moulded structural component joined to the first moulded structural component in which the second moulded structural component comprises a floor extension portion, wherein the floor of the first moulded structural component and the floor extension portion together define an extended floor of the cabin that is longer than the floor of the first moulded structural component along the direction of the principal axis of the first moulded structural component.

### BRIEF DESCRIPTION OF DRAWINGS

The invention will now be described with reference to the accompanying, of which:

FIG. 1 shows a perspective view of a moulded structural component;

FIG. 2 shows a perspective view of a cabin of a passenger vehicle including the moulded structural component of FIG. 1;

FIG. 3 shows a side view of the moulded structural component of FIG. 1;

FIG. 4 shows a schematic view of the moulding tools for moulding the structural component of FIG. 1;

FIG. 5 is a partial perspective view of the moulded structural component of FIG. 1; and

FIG. 6 is a schematic representation of a cabin of a passenger vehicle including the moulded structural component of FIG. 1.

### DETAILED DESCRIPTION

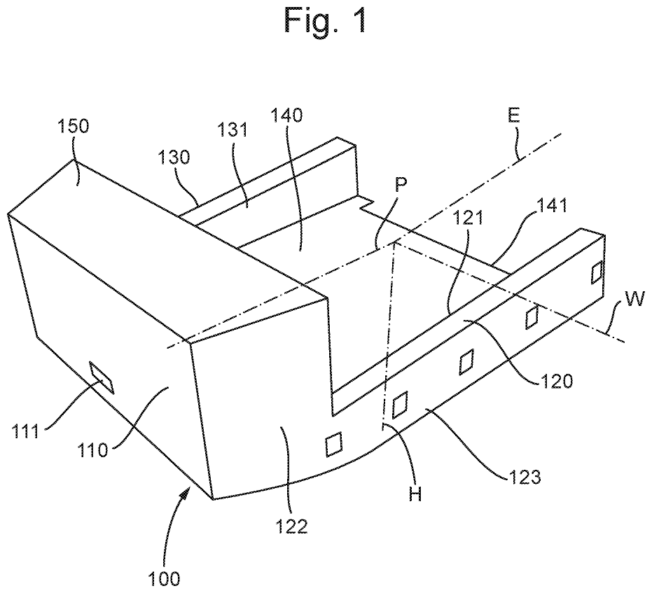

FIG. 1 shows a moulded structural component 100 suitable for use as part of the cabin of a passenger vehicle. The moulded structural component 100 is made of a carbon fibre-reinforced composite material. The moulded structural component 100 comprises a front lateral wall 110, a first side structure 120, a second side structure 130, a floor 140 and a lateral strengthening member 150, which together partially define an internal area of the structural component within which a passenger may be housed in the cabin of a passenger vehicle. The structural component 100 has a principal axis P, shown in FIG. 1, which is parallel to the floor and lies along a direction generally perpendicular to the front lateral wall 110, extending from the front end to the rear end of the structural component.

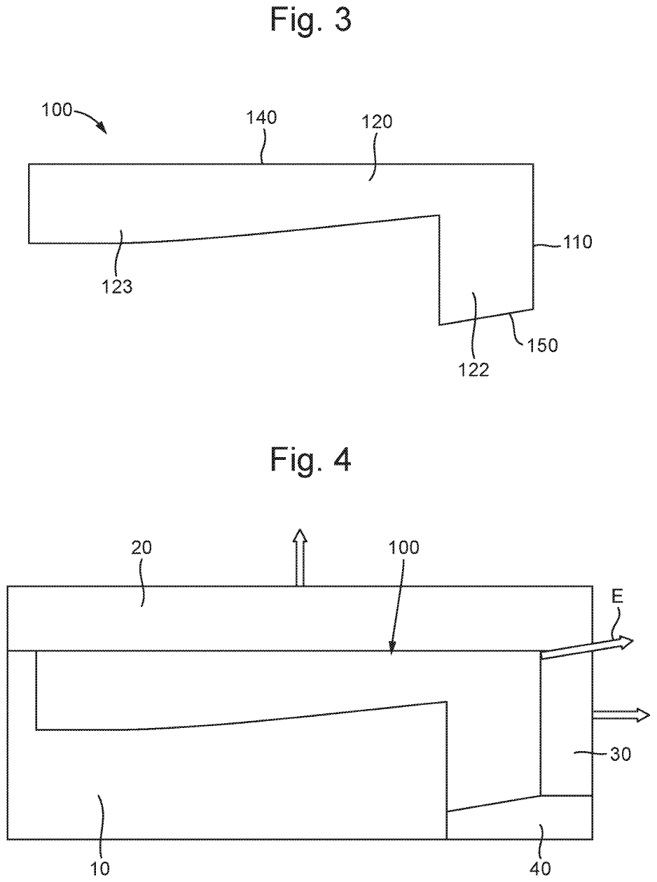

The floor 140 generally defines a plane extending between the front lateral wall 110, first side structure 120, and second side structure 130, and which has an axis H normal to the plane of the floor that extends along the height direction of the structural component. At a front end of the floor 140 it meets the front lateral wall 110, which extends away from the floor along a direction generally perpendicular to the plane of the floor. The front wall extends along the full width of the structural component 100. At opposing sides of the floor 140, the floor respectively meets the opposing side structures 120, 130, which also extend away from the floor along the direction generally perpendicular to the plane of the floor, in the same direction as the front lateral wall 110. Each opposing side structure 120, 130 includes a front portion 122 and a central portion 123. The front portion 122, 132, of each side structure 120, 130, is substantially the same height as the front lateral wall 110 and meets the front lateral wall 110 at its front end. The central portion 123, 133, of each opposing side structure 120, 130 is shorter than the front portion 122, 132, in the direction perpendicular to the floor, as this section will generally correspond to the door sill region of the cabin of the passenger vehicle. This gives each side structure a general L-shape when the structural component is viewed from the side, as can be seen in FIG. 3.

The floor 140 specifically meets inwardly-facing sidewalls 121, 131, of the opposing side structures 120, 130. Each opposing side structure 120, 130 comprises a substantially hollow beam that extends away from the front lateral wall 110 along the opposing longitudinal edges of the floor 140, generally along the direction of the principal axis P, and act as a longitudinal strengthening members. These hollow beam sections of the opposing side structures 120, 130 corresponds to the central portions 123, 133 described previously. At the front portion 122, 132 of the opposing side structures 120, 130, these inwardly-facing sidewalls 121, 131 extend up along the direction perpendicular to the floor and meet a lateral strengthening member 150, which is discussed in more detail below. At the central portion 123, 133 of the opposing side structures 120, 130, the inwardly-facing sidewalls 121, 131 initially extend upwards along the direction perpendicular to the floor before extending away from each other to define the upward facing surfaces of the hollow beam sections of the opposing side structures 120, 130. As can be seen in FIG. 3, the height of these hollow beam sections increases towards the rear end of the structural component, but always remains significantly shorter than the front portion 122, 132.

The opposing side structures 120, 130, comprising both the front portion and the central portion, extend from the front lateral wall 110 generally along the direction of the principal axis P to a rear end of the structural component 100. The floor 140 also extends from the front lateral wall towards the rear end of the structural component. The rear edge 141 of the floor extends between the rear ends of the opposing side structures 120, 130. In this embodiment, the rear edge of the floor does not extend in a straight line between the rear ends of the opposing side structures 120, 130 (although this would be possible), but instead extends a short distance away from each opposing side structure in the direction perpendicular to the principal axis P, before following a U-shaped path across the central width region of the structural component such that most of the rear edge 141 of the floor is inset towards the front side of the structural component from the rear end. The opposing side structures 120, 130 and the floor 140 define an open rear end of the structural component, meaning there is no rear lateral wall that opposes the front lateral wall 110. As will be described in more detail below, this enables the structural component to be more advantageously extracted from a moulding tool.

The structural component 100 also comprises a lateral strengthening member 150. The lateral strengthening member is a wall that extends from the top of the lateral wall 110 towards the rear end of the structural component. The lateral strengthening member 150 extends across the full width of the structural component and meets the front portion 122, 132, of each side structure 120, 130 at each side. The length of the lateral strengthening member 150 along the direction of the principal axis P is the same as the length of the front portions 122, 132, of each side structure 120, 130 along the direction of the principal axis P. Accordingly, the lateral wall 110, the front portions 122, 132, of each side structure 120, 130, the floor 140 and the lateral strengthening member 150 define a space that is surrounded on five sides and open from the rear side of the structural component. This space will correspond to the passenger footwell in the cabin of the passenger vehicle. The combination of these elements of the structural component provide a strong front portion of the structural component, that will protect a passenger from front impacts.

The inwardly-facing surface of the floor, i.e. which faces into the space defined inside the front lateral wall 110, first side structure 120, second side structure 130, and floor 140 is substantially flat and continuous between the front lateral wall 110, first side structure 120, second side structure 130 and the rear edge 141. This increases the strength of the floor and improves its response in impacts that transmit forces through the plane of the floor. Since services, provided by pipes and wiring and the like, will generally need to be provided into the interior of the cabin, one or more openings 111 are provided through the front lateral wall 110. If this is not possible and a discontinuity or non-flat section of floor must be provided, this should be arranged away from the central 50% of the floor along both the length and width of the floor to maintain strong central regions of the floor, and the discontinuities or non-flat sections should be limited in area to maximise the area of flat continuous floor.

As shown in FIG. 1, the distance between the inwardly-facing sidewalls 121, 131, of the opposing side structures 120, 130, measured in the width direction of axis W that is perpendicular to the principal axis P and the axis H normal to the plane of the floor, is substantially constant or increases from the front end of the structural component to the rear end of the structural component, to enable the structural component to be demoulded generally along the direction of the principal axis P, as will be described in more detail below. The interior space of the structural component, which is defined by the inwardly-facing surfaces of the front lateral wall 110, sidewalls 121, 131, of the opposing side structures 120, 130, floor 140 and lateral strengthening member 150, is such that substantially all distances in the interior space between the first and second sidewalls 121, 131, the floor 140 and the lateral strengthening member 150, measured in cross section in a plane perpendicular to the principal axis, are substantially constant or increase as the plane is moved along the principal axis P from the front lateral wall 110 to the rear end of the structural component. Again, this facilitates demoulding of the structural component generally along the direction of the principal axis P.

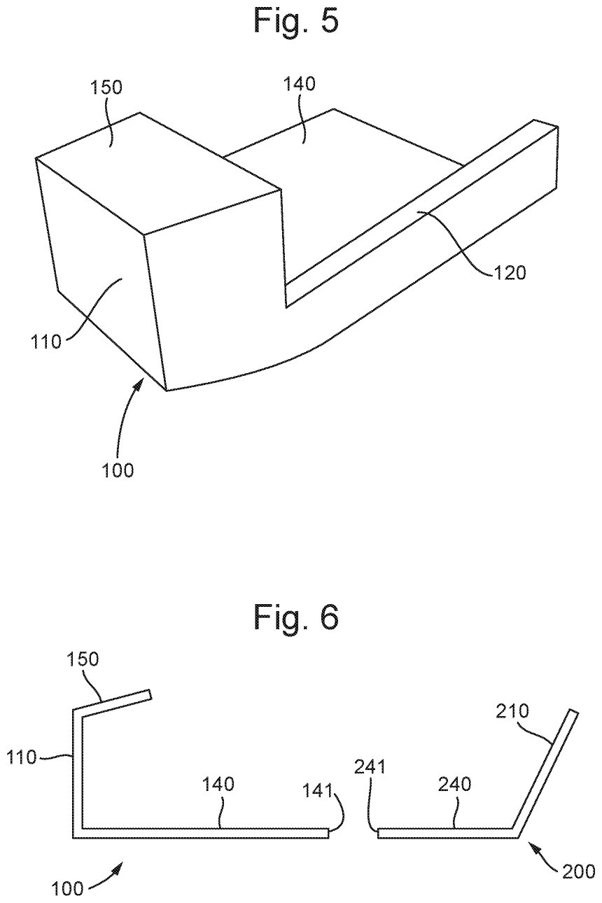

The moulding and demoulding process will now be described in more detail, with particular reference to FIGS. 4 and 5. FIG. 4 shows a moulding apparatus comprising a rigid lower tool part 10, a rigid upper tool part 20, and two rigid front tool parts 30, 40. Not shown in the side view of FIG. 3 is opposing rigid side tool parts.

To manufacture the structural component shown in particular in FIGS. 1 and 3, carbon fibre reinforcement is positioned in the moulding apparatus in a conventional manner and the various tool parts are closed to define a space between the rigid tool parts that corresponds to the shape of the structural component 100 described above. FIG. 4 illustrates which surfaces are defined by which tool parts described above. In particular, the surface of the lower tool part 10 will define the inwardly-facing surfaces of the front lateral wall 110, sidewalls 121, 131, of the opposing side structures 120, 130, floor 140 and lateral strengthening member 150, as well as part of the upwardly-facing surfaces of the hollow beam portions of the opposing side structures. The outwardly-facing surface of the floor 140 is defined by the upper tool part 20. The outwardly-facing surface of the front lateral wall 110 is defined by a first front tool part 30. The outwardly-facing surface of the lateral strengthening member 150 is defined by a second front tool part 40, although the first and second front tool parts could also be integrated into a single front tool part. Finally, the outwardly-facing surfaces of the opposing side structures 120, 130, including most of the upwardly-facing surfaces of the hollow beam portions of the opposing side structures, are defined by respective side tools (not shown). In order to mould these opposing side structures as hollow beam portions with internal walls, the side tools include several inflatable semi-rigid plastic cores, which define the internal faces of the hollow portions of the opposing side structures 120, 130.

With the carbon fibre reinforcement positioned in the space between these various tool parts, the resin material is introduced into the space between the tool parts in a conventional manner to form a carbon fibre-reinforced composite structural component having the shape described above.

To remove the structural component from the moulding apparatus, the inflatable semi-rigid plastic cores are deflated and extracted through respective openings of the opposing side structures 120, 130. Then, the upper tool 20 is moved away from the outwardly-facing surface of the floor 140, along the direction of the axis H shown in FIG. 1, and the front tool parts 30, 40 are removed from the outwardly-facing surfaces of the front lateral wall 110 and the lateral strengthening member 150 in this case along the direction of the principal axis P, as shown in FIG. 4. Not shown in FIG. 4 is the removal of the two side tools away from each other and from the opposing side structures 120, 130 along the direction of the axis W shown in FIG. 1. The removal of these tool parts leaves the structural component 100 on the lower tool 10. To extract the structural component 100 from the lower tool part 10, the structural component may be moved in pure translation along a direction generally aligned with the principal axis P such that the structural component 100 slides off the lower tool part 10 front-side first. In this embodiment, the structural component 100 is extracted along an extraction direction E, shown in FIGS. 1 and 4, that defines an angle of less than 10° to the direction of the principal axis P. In particular, the extraction direction is inclined away from the principal axis P towards the axis H in the downward direction. In this embodiment, the slight difference between the extraction direction E and the principal axis P is used to accommodate the shape of the substantially hollow beam located at the central portion 123, 133 of the opposing side structures 120, 130. In particular, this difference is provided because part of the upwardly-facing surfaces of these structures is defined by the lower tool 10, and because there is a small increase in height of these hollow beam portions of the opposing side structures 120, 130, towards the rear of the structural component. However, in other embodiments, if the lower tool were used only to define the inwardly-facing surfaces of the opposing side structures 120, 130, then the extraction direction E could be more closely aligned with the principal axis P. Nonetheless, even in the arrangement shown, the structural component 100 can be removed from the lower tool 10 by a pure translational movement along a direction generally aligned with the principal axis, which simplifies extraction of the component from the lower tool 10.

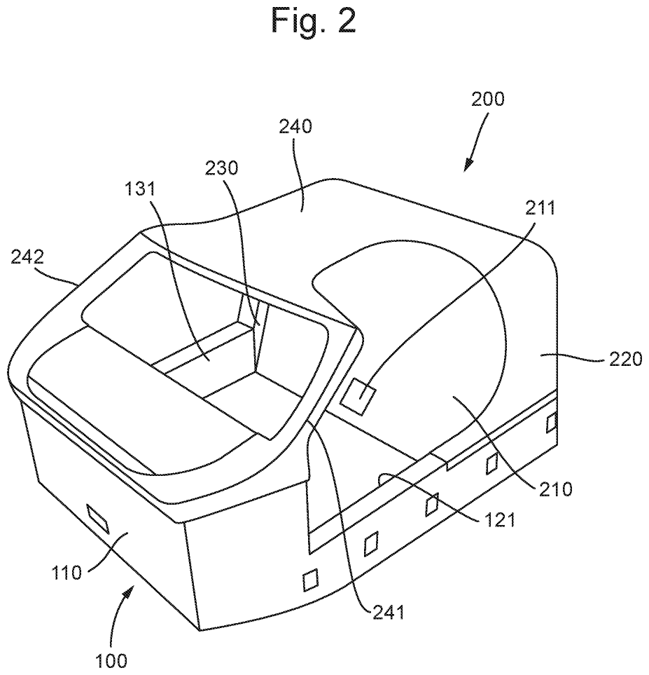

Returning to FIG. 2, this shows the structural component 100 once it has been joined with a second moulded structural component 200 to form the cabin of a passenger vehicle. This will now be described in more detail.

The cabin shown in FIG. 2 is formed of precisely two separate moulded structural components. This is because it is advantageous to use as few separate moulded components as possible, since the use of more separate components requires more joins to be made, and each join is a point that may be subject to adjustments for manufacturing tolerances, requires the use of extra joining materials, and also introduces a point of weakness into the cabin.

The moulded structural component 100 acts as a front-lower part of the cabin, defining the floor of the cabin and the front of the cabin, including the passenger foot well, as well as the door sill regions of the cabin. A second moulded structural component 200 provides the upper-rear part of the cabin. The second structural component 200 comprises a rear lateral wall 210, opposing side structures 220, 230, and a roof 240.

The second structural component 200 is joined to the first structural component 100 such that the rear lateral wall 210 is joined to the floor 140 substantially along the rear edge 141 of the floor 140, which, as noted above, is inset from the rear end of the structural component. The rear lateral wall 210 opposes the front lateral wall 110, being spaced from the front lateral wall along the direction of the principal axis. The cabin shown in FIG. 2 would correspond to a two-seater vehicle and the rear lateral wall, which extends upwards away from the floor 140, may be used to support the seat backs of seats arranged inside the cabin. The second structural component 200 is also joined to the first structural component 100 such that the opposing side structures 220, 230 meet, respectively, the opposing side structures 120, 130, of the first structural component. Here, the opposing side structures 220, 230 extend generally upwards along the direction of axis H to form, effectively, the door pillar region of the cabin. It will be noted that the opposing side structures 220, 230 of the second structural component 200 meet the rear lateral wall 210 and they extend together upwards along the direction of axis H to form an enclosed rear section of the cabin.

The rear lateral wall 210 and opposing side structures 220, 230 transition into a roof 240 of the second structural component 200. In this embodiment, the cabin is configured to use gull-wing doors, and so the roof 240 is shaped accordingly to accommodate this door type, and so has a narrow central section between the rear and front ends of the roof. At a front end of the roof 140, the second structural component provides opposing windscreen pillars 241, 242. These windscreen pillars 241, 242 extend forwards and down away from the roof, and are joined at their lower end to the first moulded structural component 100. In particular, these windscreen pillars 241, 242 join to the first moulded structural component 100 where the lateral strengthening member 150 meets the front portions 122, 132, of the opposing side structures 120, 130, of the first structural component.

As shown in FIG. 2, in order to accommodate the flat continuous floor 140 of the first moulded structural component, which prevents any services provided by pipes and wires and the like from being introduced into the cabin through the floor, the rear lateral wall 210 of the second structural component 200 is provided with at least one opening 121, through which pipes and wiring and the like may be introduced into the inside of the cabin of the vehicle.

As has been described above, an advantage of the present design of the first moulded structural component 100 is that it can be incorporated into vehicles with different length cabins. The cabin shown in FIG. 2 uses the first moulded structural component 100 in its shortest configuration, with the rear lateral wall of the second structural component 200 extending up away from the floor 140 substantially at the rear edge 141 of the floor. However, the length of the cabin can be varied by using different designs of second structural component 200. This advantageously means that instead of different first and second structural components having to be designed for each vehicle, the same first structural component may be used, with only the second structural component having to be varied depending on the nature of each vehicle.

FIG. 6 illustrates schematically how a different second structural component 200 may be used with the same first structural component 100 to provide a different length cabin. In particular, the second structural component 200 may be provided with a floor extension portion 240. The floor extension portion 240 is a section of the cabin floor that is provided by the second structural component 200. This floor extension portion 240 generally defines a plane that extends from a front edge 241 to a rear lateral wall 210 provided by the second structural component. When the first structural component 100 is joined to the second structural component, the floor 140 and the floor extension portion 240 are arranged generally co-planar and the rear edge 141 of the floor 140 joined to the front edge 241 of the floor extension portion. There may also be some overlap between the floor 140 and the floor extension portion 240 to provide a greater area over which the join may be made. Of course, the second structural component 200 may also need to be provided with opposing side structures that form extension portions to the length of the opposing side portions 120, 130 of the first structural component 100, depending on the desired length of the cabin, so that these opposing side structures also extend along the full length of the cabin.

In this arrangement, the length of the cabin along the direction of the principal axis P of the first structural component is defined by the combined length of the floor 140 and the floor extension portion 240. As can be seen schematically in FIG. 6, the rear lateral wall 240 may thereby be spaced further from the front lateral wall 140 than in the configuration shown in FIG. 2. The floor extension portion 240 can be used to define any fraction of the total length of the floor of the cabin, but preferably the length of the floor extension portion 240 should be at least 20% of the length of the floor 140 of the first structural component.

1. A moulded structural component for a cabin of a passenger vehicle, the structural component comprising:
a lateral wall facing a rear end of the structural component, the lateral wall being spaced from the rear end of the structural component along a principal axis of the structural component;
opposing first and second sidewalls, each extending from the lateral wall towards the rear end of the structural component; and
a floor extending between the lateral wall and the first and second sidewalls and towards the rear end of the structural component, the lateral wall, the first and second sidewalls and the floor being integral and together defining an interior space of the structural component for housing one or more passengers;
wherein the first and second sidewalls and the floor define an open rear end of the structural component and the distance between interior-side faces of the first and second sidewalls is substantially constant or increases from the lateral wall towards the open rear end of the structural component along the direction of the principal axis such that the structural component may be demoulded from a rigid tool part of a moulding apparatus forming the structural component along a direction within 20° of the principal axis of the structural component.

2. The moulded structural component according to claim 1, wherein substantially all distances in the interior space between the first and second sidewalls and the floor measured in cross section in a plane perpendicular to the principal axis are substantially constant or increase as the plane is moved along the principal axis from the lateral wall to the rear end of the structural component.

3. The moulded structural component according to claim 1, wherein the first and second sidewalls are part of respective first and second longitudinal strengthening members, such as substantially hollow beams, extending from the lateral wall towards the rear end of the structural component.

4. The moulded structural component according to claim 1, wherein a front portion of each sidewall, at an end proximate the lateral wall, extends further from the floor than a central portion of said sidewall. 5. The moulded structural component according to claim 1, further comprising a lateral strengthening member extending between the first and second sidewalls at a front portion of each sidewall, at an end proximate the lateral wall, said strengthening member being spaced from the floor along a direction perpendicular to a plane generally defined by the floor.

6. The moulded structural component according to claim 5, wherein the lateral strengthening member meets the lateral wall and extends from the lateral wall towards the rear end of the structural component.

7. The moulded structural component according to claim 5, wherein a distance between interior-side faces of the floor and the lateral strengthening member is substantially constant or increases from the lateral wall towards the open rear end of the structural component along the full length of the lateral strengthening member along the direction of the principal axis.

8. (canceled)

9. The moulded structural component according to claim 1, wherein a profile of an interior-side face of the floor in cross section in a plane perpendicular to the principal axis is substantially constant as the plane is moved along the principal axis from the lateral wall to the rear end of the structural component.

10. (canceled)

11. (canceled)

12. (canceled)

13. (canceled)

14. (canceled)

15. (canceled)

16. (canceled)

17. (canceled)

18. The moulded structural component according to claim 1, wherein the moulded structural component is formed as a single fibre-reinforced composite piece.

19. (canceled)

20. (canceled)

21. (canceled)

22. A method of manufacturing a structural component for a cabin of a passenger vehicle, the method comprising:
moulding the structural component between at least a rigid inner tool part and an outer tool part of a moulding apparatus, whereby the structural component comprises:
a lateral wall facing a rear end of the structural component, the lateral wall being spaced from the rear end of the structural component along a principal axis of the structural component;
opposing first and second sidewalls, each extending from the lateral wall towards the rear end of the structural component; and
a floor extending between the lateral wall and the first and second sidewalls and towards the rear end of the structural component, the lateral wall, the first and second sidewalls and the floor being integral and together defining an interior space of the structural component for housing one or more passengers;
wherein the first and second sidewalls and the floor define an open rear end of the structural component and the distance between interior-side faces of the first and second sidewalls is substantially constant or increases from the lateral wall towards the open rear end of the structural component along the direction of the principal axis;
wherein the rigid inner tool part is located in the interior space during moulding;
removing the outer tool part; and
demoulding the structural component from the rigid inner tool part of the moulding apparatus along a direction within 20° of the principal axis of the structural component.

23. (canceled)

24. A moulded structural component for a cabin of a passenger vehicle, the structural component comprising:
a lateral wall facing a rear end of the structural component;
opposing first and second sidewalls, each extending from the lateral wall towards the rear end of the structural component; and
a floor extending between the lateral wall and the first and second sidewalls and towards the rear end of the structural component, the lateral wall, the first and second sidewalls and the floor being integral and together defining an interior space of the structural component for housing one or more passengers;
wherein the floor is substantially continuous between the lateral wall, the first and second sidewalls and a rear edge of the floor towards the rear end of the structural component.

25. (canceled)

26. The moulded structural component according to claim 25, wherein the floor is substantially flat between the first and second sidewalls along at least 10% of the length of the floor between the lateral wall and the rear edge.

27. The moulded structural component according to claim 24, wherein the floor is substantially flat between the first and second sidewalls within at least one contiguous region extending along at least 10% of the length of the floor between the lateral wall and the rear edge.

28. The moulded structural component according to claim 24, wherein, of a central 50% of the floor between the lateral wall and the rear edge, the floor is substantially flat between the first and second sidewalls along at least 10%.

29. The moulded structural component according to claim 24, wherein the floor is substantially flat between the lateral wall and the rear edge along at least 10% of the width of the floor between the first and second sidewalls.

30. The moulded structural component according to claim 24, wherein the floor is substantially flat between the lateral wall and the rear edge within at least one contiguous region extending along at least 10% of the width of the floor between the first and second sidewalls.

31. The moulded structural component according to claim 24, wherein, of a central 50% of the floor between the first and second sidewalls, the floor is substantially flat between the lateral wall and the rear edge along at least 10%.

32. (canceled)

33. (canceled)

34. A moulded structural component for a cabin of a passenger vehicle, the structural component comprising:
a lateral wall facing a rear end of the structural component, the lateral wall being spaced from the rear end of the structural component along a principal axis of the structural component;
opposing first and second sidewalls, each extending from the lateral wall towards the rear end of the structural component; and
a floor extending between the lateral wall and the first and second sidewalls and towards the rear end of the structural component, the lateral wall, the first and second sidewalls and the floor being integral and together defining an interior space of the structural component for housing one or more passengers;
wherein the first and second sidewalls and the floor define an open rear end of the structural component.

35. A cabin of a passenger vehicle, the cabin comprising a first moulded structural component according to claim 34, and further comprising a second moulded structural component joined to the first moulded structural component, the second moulded structural component comprising a second lateral wall spaced from the lateral wall of the first moulded structural component along the principal axis of the first moulded structural component, such that the length of the cabin is defined by the first and second moulded structural components together.

36. A cabin according to claim 34, comprising a second moulded structural component joined to the first moulded structural component, wherein the second moulded structural component comprises a floor extension portion, wherein the floor of the first moulded structural component and the floor extension portion together define an extended floor of the cabin that is longer than the floor of the first moulded structural component along the direction of the principal axis of the first moulded structural component.
